(19) United States
(12) Patent Application Publication
(10) Pub. No.: US 2014/0379954 A1
(43) Pub. Date: Dec. 25, 2014

(54) RELAY DEVICE, COMMUNICATION HARNESS, AND COMMUNICATION SYSTEM

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventor: Yoshiaki Hayashi, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 14/365,335

(22) PCT Filed: Dec. 14, 2012
(86) PCT No.: PCT/JP2012/082437

§ 371 Date: Jun. 13, 2014

(30) Foreign Application Priority Data
Dec. 27, 2011 (JP) 2011-286400

(51) Int. Cl. G06F 13/16; H04L 12/40

(52) U.S. Cl. CPC G06F 13/16; H04L 12/40182; H04L 2012/40215
USPC 710/310

(57) ABSTRACT

Provided are a relay device where a routing table can be replaced in order to accommodate diverse relay variations and the storage capacity of the routing table can be saved, a communication harness including the relay device and a communication system including the relay device. In the relay device, a routing program for a CPU to execute relay processing and a routing table for identifying the relay destination by the relay processing are stored in an information rewritable flash memory. The routing table includes a first table that manages whether the CAN message is to be relayed or not, a second table storing the received CAN message, a third table storing the CAN message to be transmitted (relayed), a fourth table that manages the signal storage position, and a fifth table that manages the number of effective records in the second to fourth tables.

### CROSS-REFERENCE TO RELATED APPLICATION

This application is the national phase under 35 U.S.C. §371 of PCT International Application No. PCT/JP2012/82437 which has an International filing date of Dec. 14, 2012 and designated the United States of America.

### FIELD

The present invention relates to a relay device that performs relay between different communication buses, and relates to a relay device where a routing table can be replaced in order to accommodate diverse relay variations and the storage capacity of the routing table can be saved, a communication harness including the relay device, and a communication system including the relay device.

### BACKGROUND

In the field of vehicle control, a structure is typical in which a multiplicity of control units (ECUs: electric control units) that control devices disposed in a vehicle are connected by communication buses and data is transmitted and received thereamong to perform a variety of processing. Since the number of ECUs connected to one communication bus is limited or since the communication speed differs according to the role of the ECU, a structure is adopted in which the ECUs are divided into a plurality of groups, each group is connected to one communication bus and two communication buses are connected by a relay device (gateway).

The relay device identifies the information received from one communication bus by, in the case of the CAN (controller area network), the CAN ID, refers to a routing table that identifies whether relay is necessary or not and the communication bus of the relay destination for each CAN ID, and transmits the information from the communication bus of the relay destination to implement relay processing (Japanese Patent Application Laid-Open No. 2009-049944 and WO 2008/126698, etc.).

### SUMMARY

In the structure described in Japanese Patent Application Laid-Open No. 2009-049944 or 2, a routing table is stored in a memory, and from a CPU based on a relay processing program or from a circuit structured so as to perform relay processing, every time information is received from one communication bus or every time the timing to transmit one piece of information comes, processing of reading the correspondence between the ID and the communication bus of the relay destination from the routing table in the memory and identifying the communication bus of the relay destination is performed every time. This structure has problems in that the processing is delayed by the reading from the memory and that the information amount of the routing table stored in the memory is large.

Moreover, as disclosed in Patent Japanese Patent Application Laid-Open No. 2006-340099, for in-vehicle ECUs, recently, microcomputer (hereinafter, referred to as micro) processing based on a rewritable computer program is adopted in order to avoid the manufacture of hardware for each of the different vehicle models or options for reduction in the cost of hardware.

From such circumstances, the reality is that a structure using a micro that causes the CPU to read a computer program incorporating the contents of the routing table and executes it is adopted resultingly in order to increase the processing speed and to save memory. That is, the relay destination when certain information is received is already prescribed in the executable code of the computer program, and table reading processing is unnecessary. Patent Document 2 also describes that when the relay device is activated, the routing table stored in the memory is read, converted and incorporated in a relay processing circuit for use.

On the other hand, since functions implemented by electronic control are increasing, the number of in-vehicle ECUs is enormous. For the relay device, not information relay between two communication buses but information relay processing among three or more communication buses is becoming necessary. Therefore, there are diverse relay variations such that certain information is relayed from one communication bus to the other three communication buses and two pieces of information received from two communication buses, respectively, are collectively transmitted from another communication bus. Further, since the number of communication busses and the kind of ECU connected to each communication bus differ among vehicle manufacturers, vehicle models or options, relay variations increase. In the structure in which the CPU is caused to read the computer program incorporating the contents of the routing table, since it is necessary to develop a relay processing program for each of the different variations, it is difficult to curb the cost of development.

Moreover, in the field of vehicle control, it is particularly required to save memory. Therefore, in the structure having a routing table storing relay destinations and the like like a table for every piece of information so that the routing table can accommodate diverse relay variations, the storage capacity of the routing table is large, which is undesirable.

The present invention is made in view of such circumstance, and an object thereof is to provide a relay device where a routing table can be replaced in order to accommodate diverse relay variations and the storage capacity of the routing table can be saved, a communication harness including the relay device and a communication system including the relay device.

A relay device according to the present invention is provided with: a plurality of communication units connected to different communication buses, respectively; a rewritable storage unit; and a processor that executes relay process of transmitting one or a plurality pieces of information received at one or a plurality of the communication units, by another one or a plurality of the communication units, based on a computer program stored in the storage unit, and is characterized in that the storage unit stores a routing table that identifies a relay destination of the received information and that the routing table includes: a first table recording necessity or unnecessity of relay of the information for each piece of identification information of the information and a storage destination of the information when relay is necessary; a second table for recording an area where received information is stored; a third table including a relay destination and an area storing information associated with the relay destination and to be relayed; a fourth table recording index information representative of a storage destination of information; and a fifth table recording the number of pieces of information in the third table.

In the relay device according to the present invention, the processor is provided with execution means including: means for referring to the first table when information is received at any of the communication units; means for referring to the first table for the storage destination of the information when it is necessary to relay the information, based on the first table; and means for storing the information in the storage destination in the second table.

In the relay device according to the present invention, the second table includes a relay destination so as to be associated with the storage area, and the processor is provided with execution means including: means for referring to the first table when information is received by any of the communication units; means for referring to the first table for the storage destination of the information when it is necessary to relay the information, based on the first table; and means for transmitting the information to the relay destination associated with the storage destination in the second table.

In the relay device according to the present invention, the processor is provided with execution means including: means for referring to the third table; means for identifying the storage destination, in the second table, of the information stored in the storage destination of the third table, based on the fourth table; means for reading information from the identified storage destination; means for storing the read information into the storage destination of the third table; and means for transmitting the stored information to the associated relay destination.

In the relay device according to the present invention, the processor is provided with means for reading the number of pieces of information from the fifth table, and refers to the third table by an amount equivalent to the number of read pieces of information.

A communication harness according to the present invention is characterized by including the relay device of any of the above-described aspects of the invention and a plurality of communication buses connected to the communication units of the relay device, respectively.

A communication system according to the present invention is characterized by including: a plurality of communication devices that transmit and receive information; a plurality of communication buses connected to the communication devices, respectively; and the relay device of any of the above-described aspects of the invention to which the communication buses are connected.

According to the present invention, a rewritable routing table is stored in the storage unit of the relay device, and the routing table identifies the relay destination of the information received from any of the communication buses and includes the first table recording the necessity or unnecessity of relay and the storage destination when relay is necessary, the second table recording the area where received information is stored, the third table storing the relay destination and the information to be relayed associated with the relay destination, the fourth table recording the index information representative of the storage destination of the information, and the fifth table recording the number of pieces of information in the third table. Even if the contents of the second table and the third table are changed to different contents, since the first, fourth and fifth tables corresponding thereto are present, it is unnecessary to change the procedure executed by the processor that executes the processing based on the computer program. Further, for example, it is necessary for the second table to store only the information that needs to be relayed. It is also necessary for the third table to store only the information to be transmitted.

According to the present invention, when the received information needs to be relayed, the first table stores not only the necessity or unnecessity of relay but also the storage destination in the second table, and the received information is stored in the storage destination with reference to the first table by the processor.

According to the present invention, the storage area of the second table is associated with the relay destination when the received information is relayed as it is, and when the received information needs to be relayed, the received information is relayed to the relay destination associated with the storage area in the second table which is the storage destination included in the first table by the processor.

According to the present invention, based on the index information of the fourth table, the processor identifies the storage destination, in the second table, of the information stored in the third table, reads information from the storage destination, and stores it into the storage destination in the third table. In a case where the received information further includes a plurality of pieces of information, when it is necessary to create information to be relayed, from the received pieces of information at the time of relay, the capacity of the routing table can be saved because of the presence of the index information.

According to the present invention, since the number of pieces of information in the third table is recorded in the fifth table, the processor can successively transmit the pieces of information in the third table according to the number of pieces of information irrespective of the contents of the third table.

According to the present invention, the routing table can be replaced in order to accommodate diverse relay variations. By executing a specific instruction code also for the replaced routing table, it is possible to manage the received information in accordance with the replaced different routing table and create the information to be relayed. Further, the routing table in the present invention is constituted by a plurality of tables associated with one another and, for example, does not consume memory unnecessarily.

According to the present invention, it is unnecessary to re-create the computer program for the processor to execute the relay processing according to each of the different relay variations. Thereby, the cost of development can be curbed. In addition, since it is unnecessary to re-create the computer program for executing the relay processing, in inspecting the relay device of the present invention, it is unnecessary to inspect the computer program every time for each of the different relay variations and it is necessary to inspect only the operation including different routing tables accommodating the different relay variations. Consequently, it is possible to reduce the number of items of the inspection after the construction of the relay device and the communication system including the relay device to curb the cost of manufacturing.

The above and further objects and features will more fully be apparent from the following detailed description with accompanying drawings.

### BRIEF DESCRIPTION OF THE DRAWINGS

FIG. 1 is a block diagram showing the structure of an in-vehicle communication system in the present embodiment.

FIG. 2 is a schematic view schematically showing the contents of the information stored in a flash memory.

FIG. 3 is an explanatory view showing an example of the contents of a first table of a routing table.

FIG. 4 is an explanatory view showing an example of the contents of a second table of the routing table.

FIG. 5 is an explanatory view showing a reference example.

FIG. 6 is an explanatory view showing an example of the contents of a third table of the routing table.

FIG. 7 is an explanatory view showing an example of the contents of a fourth table of the routing table.

FIG. 8 is an explanatory view showing an example of the contents of a fifth table of the routing table.

FIG. 9 is a flowchart showing an example of the processing procedure of reception processing at a relay device.

FIG. 10 is a flowchart showing an example of the processing procedure of immediate relay processing at the relay device.

FIG. 11 is a flowchart showing an example of the processing procedure of transmission processing at the relay device.

FIG. 12 is a flowchart showing the example of the processing procedure of the transmission processing at the relay device.

### DETAILED DESCRIPTION OF NON-LIMITING EXAMPLE EMBODIMENTS

Hereinafter, the present invention will be concretely described based on the drawings showing an embodiment thereof.

In the following embodiment, description will be given with an example where the present invention is applied to an in-vehicle communication system that controls in-vehicle devices.

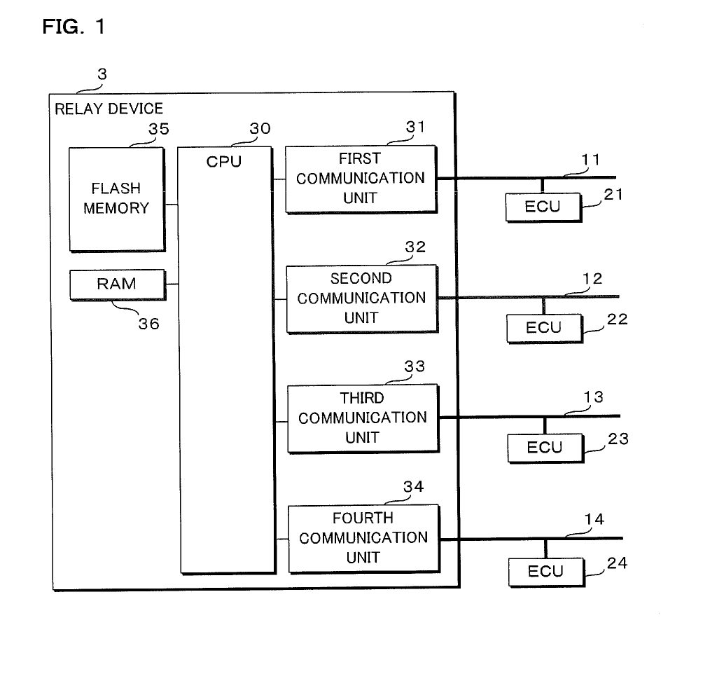

FIG. 1 is a block diagram showing the structure of an in-vehicle communication system in the present embodiment. The in-vehicle communication system includes a plurality of communication buses 11, 12, 13 and 14, ECUs 21, 22, 23 and 24 connected to the communication buses 11, 12, 13 and 14, respectively, and a relay device 3 that performs information relay processing among the communication buses 11, 12, 13 and 14.

In the first embodiment, communications through the communication buses 11, 12, 13 and 14 conform to the CAN protocol. The communication buses 11, 12, 13 and 14 are distinguished by the kinds of objects to be controlled by the connected ECUs 21, 22, 23 and 24. In other words, they are distinguished by the kinds of transmitted and received information. The communication speed may be a different setting for each of the communication buses 11, 12, 13 and 14. For example, to the communication bus 11, a plurality of ECUs 21 that perform control of the cruise control system are connected, and information on the control system such as the vehicle speed is transmitted and received therethrough. To the communication bus 12, a plurality of ECUs 22 that perform control of the power control system are connected, and information on the power control system such as the battery information is transmitted and received therethrough. To the communication bus 13, a plurality of ECUs 23 that perform control of the accessory system such as the car navigation system are connected, and information on the multimedia system such as the time information and the position information is transmitted and received therethrough. To the communication bus 14, a plurality of ECUs 24 that perform control of the body are connected, and information relates to the door lock and security are transmitted and received therethrough.

The relay device 3 is provided with a CPU (central processing unit) 30, a first communication unit 31, a second communication unit 32, a third communication unit 33, a fourth communication unit 34, a flash memory 35 and a RAM (random access memory) 36.

Using the RAM 36 as the transmission buffer or the reception buffer, the CPU 30 executes transmission and reception through the first to fourth communication units 31 to 34 based on a routing table 37 and a later-described computer program stored in the flash memory 35 to implement relay processing. The CPU 30 may be replaced by an MPU (micro processing unit).

The first to fourth communication units 31 to 34 each include a CAN controller and a CAN transceiver, and implements transmission and reception of a CAN message including various pieces of information based on the CAN protocol. The first communication unit 31 is connected to the communication bus 11, the second communication unit 32, to the communication bus 12, the third communication unit 33, to the communication bus 13, and the fourth communication unit 34, to the communication bus 14.

The flash memory 35 is a rewritable non-volatile memory, and stores the computer program and the routing table read by the CPU 30 as described later. As a substitute for the flash memory 35, a non-volatile memory such as an EEPROM (trademark) may be used.

The RAM 36 is used as the transmission and reception buffer. The CPU 30 stores the CAN messages received by the first to fourth communication units 31 to 34 and the CAN messages transmitted by the first to fourth communication units 31 to 34 in the RAM 36.

The CPU 30, the CAN controller units in the first to fourth communication units 31 to 34, the flash memory 35 and the RAM 36 may constitute a micro.

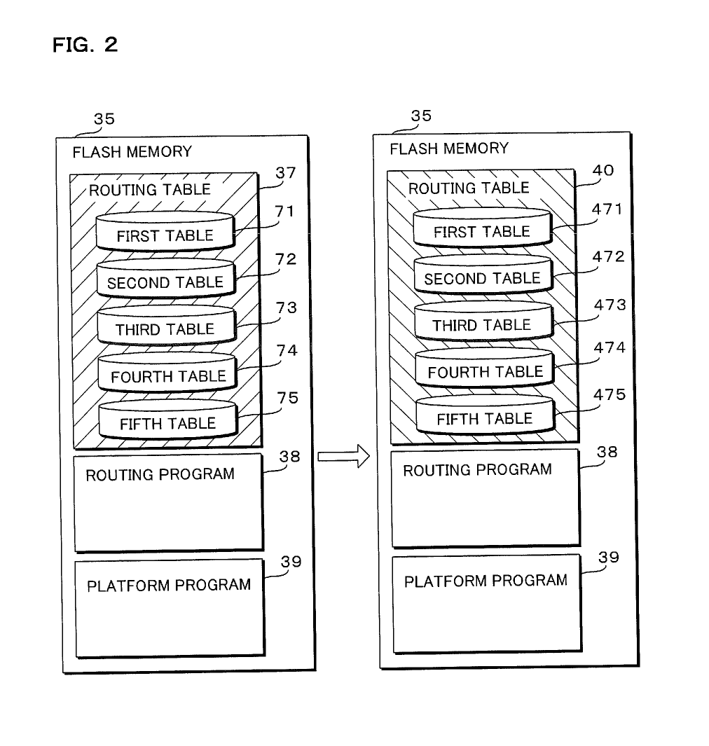

FIG. 2 is a schematic view schematically showing the contents of the information stored in the flash memory 35. The flash memory 35 stores the routing table 37, a routing program 38 and a platform program 39. A non-illustrated driver program and the like may be stored in addition.

The platform program 39 is a program where basic input and output processing such as the processing of notifying the CPU 30 of a reception interrupt when a CAN message is received at the first to fourth communication units 31 to 34 and writing it into the reception buffer of the RAM 36 and the processing of supplying a CAN message created and provided by the CPU 30 to the first to fourth communication units 31 to 34 and causing them to transmit it are commoditized among devices.

The routing program 38 is a program for implementing the relay processing by the CPU 30, that is, the processing procedure as shown in flowcharts described later. The routing program 38 includes no executable code dependent on the vehicle model or the option so that rewriting is unnecessary even when the routing table 37 is replaced with another routing table 40. In order to also accommodate the replacement routing table 40, the routing program 38 is constructed so as to include a commoditized executable code that accommodates the routing table 37, the routing table 40 and other routing tables. Details of the executable code will be described with reference to flowcharts described later.

The routing table 37 includes a first table 71 that manages whether the CAN message needs to be relayed or not, a second table 72 that stores the received CAN message and manages it, a third table 73 that stores the CAN message to be transmitted (relayed) and manages it, a fourth table 74 that manages the storage position of the signal included in the data of the received CAN message and the CAN message to be transmitted and a fifth table 75 that manages the number of effective records in the second table 72, the third table 73 and the fourth table 74.

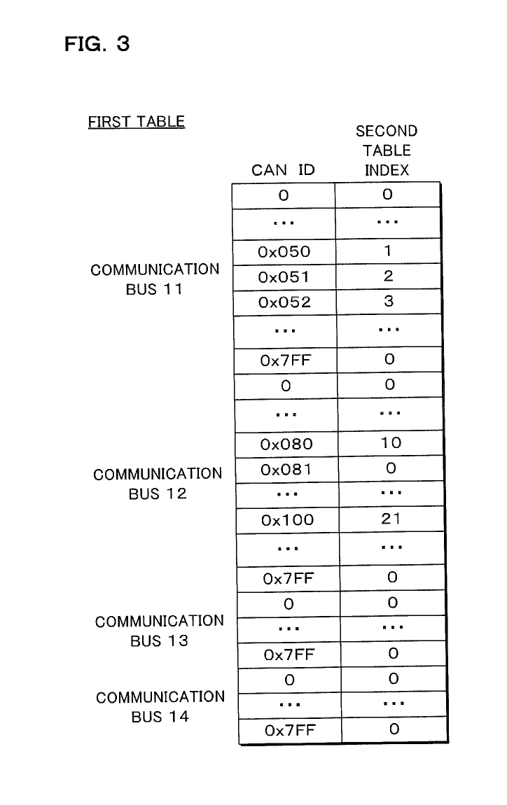

FIG. 3 is an explanatory view showing an example of the contents of the first table 71 of the routing table 37. The first table 71 includes records specific to the CAN IDs of the received CAN messages for each of the communication buses 11 to 14. In the example of FIG. 3, each record includes an index to the second table 72. The record type is determined, and the record lengths are constant. The records are stored in order from the record with a CAN ID of “0” of the communication bus 11 in order from the top of the area of the first table 71 on the flash memory 35.

The CAN ID is expressed, for example, by 11 bits, and the maximum value is 0x7FF according to the CAN rule. The index to the second table 72 is expressed, for example, by one byte, and indicates the record order in the second table 72. Whether the CAN message needs to be relayed or not is indicated by the index to the second table 72. When the index is not “0”, the CAN message needs to be relayed, and when the index is “0”, it does not need to be relayed.

In the example of the contents shown in FIG. 3, for example, the CAN message with a CAN ID of “0” received from the communication bus 11 does not need to be relayed since the index is “0”. Moreover, the CAN message with a CAN ID of “0x050” received from the first table 71 needs to be relayed since the index is not “0”, and the “1”st record of the second table 72 is referred to. The CAN message with a CAN ID of “0x051” needs to be relayed since the index is not “0”, and the “2”nd record of the second table 72 is referred to. The CAN message with a CAN ID of “0x052” also needs to be relayed since the index is not “0”, and the “3”rd record of the second table 72 is referred to.

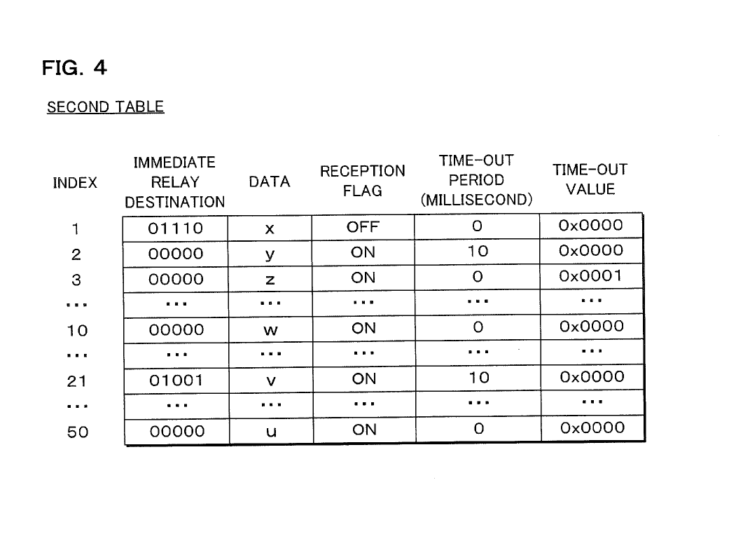

FIG. 4 is an explanatory view showing an example of the contents of the second table 72 of the routing table 37. The second table 72 includes information on the immediate relay destination corresponding to the CAN message stored in each record, data storage areas, information on a reception flag representative of whether data not having been relayed has been received or not (ON: received, OFF already relayed), the time-out period (millisecond) and the time-out value. The record type is determined, and the record lengths are constant. The records are stored in order from the first record in order from the top of the area of the second table 72 on the flash memory 35.

The immediate relay destination is expressed, for example, by five bits, and one bit is assigned to each of the communication buses 11 to 14, that is, to the first to fourth communication units 31 to 34 (one bit is a spare); the case of “0” indicates not being a relay destination, and the case of “1” indicates being a relay destination.

As the data storage area, eight bits are provided. The data is formed of a plurality of pieces of signal information. For example, the signal information on whether each vehicle door is open or closed can be indicated by one bit (1: open, 0: closed). Specifically, of the eight bits of the data part of the received CAN message, the first five bits can indicate in order whether the front seat right side door is open or closed, whether the front seat left side door is open or closed, whether the rear seat right side door is open or closed, whether the rear seat left side door is open or closed and whether the rear door is open or closed.

The reception flag is expressed, for example, by eight bits, and “ON: received” is “0x01”, and “OFF: already relayed” is “0x00”.

The time-out period is expressed, for example, by eight bits, and is the period from the reception to the time-out for each CAN message. The time-out value is expressed, for example, by 16 bits, and is the value that results after the time-out.

In the example of the contents shown in FIG. 4, for example, the immediate relay destination of the CAN message stored at the index “1” is “01110b”, the end bit corresponding to the communication bus 11 and the spare top bit are “0” and the other bits are “1”; therefore, the CAN message is immediately relayed by the communication buses 12 to 14, that is, the second communication unit 32 to the fourth communication unit 34. The data “x” of the CAN message is stored in the storage area of the pertinent record. The reception flag is rendered “OFF”. The time-out period is “0 milliseconds”, and the time-out value is “0x0000”. Moreover, although the CAN message stored at the index “2” needs to be relayed (OK), it is not relayed immediately since the immediate relay destination is “00000b”. The data “y” of the CAN message is stored in the storage area of the pertinent record, and the reception flag is “ON” until it is relayed. The time-out period is “10 milliseconds”, and “0x0001” results after the time-out.

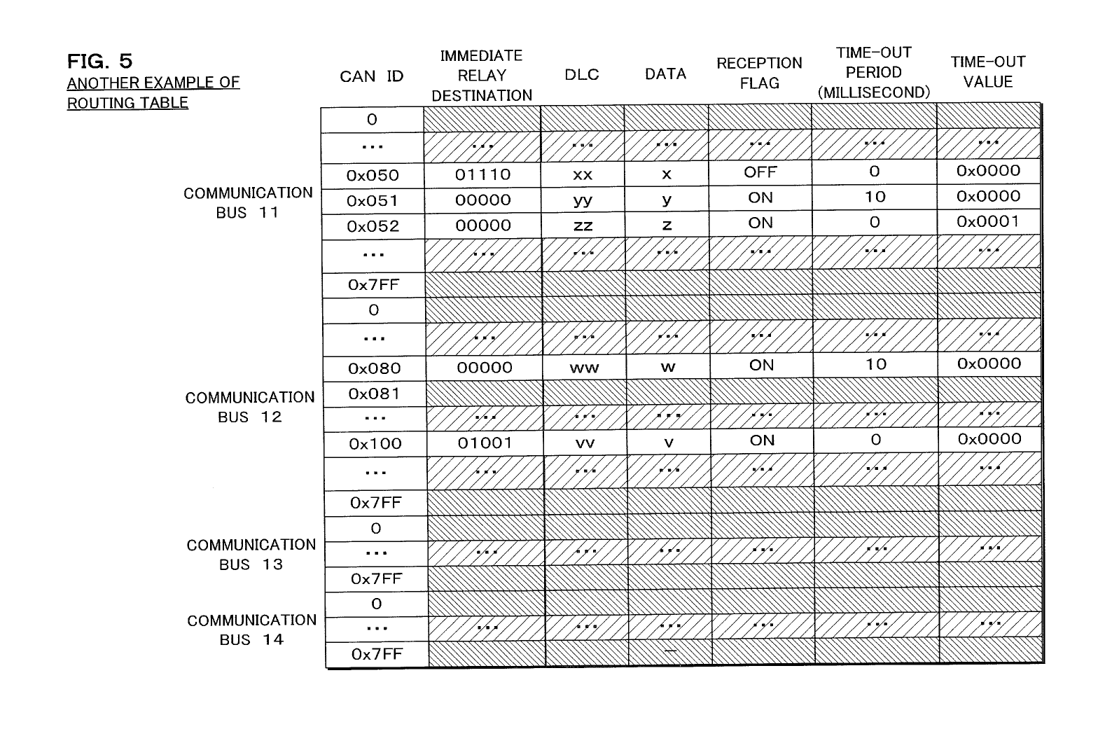

Now, as a reference, an example will be shown in which the first table 71 and the second table 72 are integrated into one table. FIG. 5 is an explanatory view showing the reference example. In the example of FIG. 5, a routing table is realized in the form where the record contents of the second table 72 are added to each record of each CAN ID in the first table 71. The hatched areas in the records in FIG. 5 are not used when relay is unnecessary. Therefore, the storage capacity therefor is redundant. In this regard, as shown in FIG. 3 and FIG. 4, since the table is divided into the first table 71 and the second table 72 and associated with index information, the overall storage capacity of the routing table 37 can be saved, so that the flash memory 35 can be saved. In addition, the second table 72 is read with reference to the index information. Therefore the CPU 30 that executes the processing based on the routing program 38 can identify, from the first table 71, from which address on the flash memory 35 the record is to be read, even when the contents of the second table 72 are different. Therefore, even when replacement with another routing table 40 is made, it is unnecessary to change the processing by the CPU 30 based on the routing program 38, since the first table 71 and the second table 72 are also replaced with a first table 471 and a second table 472.

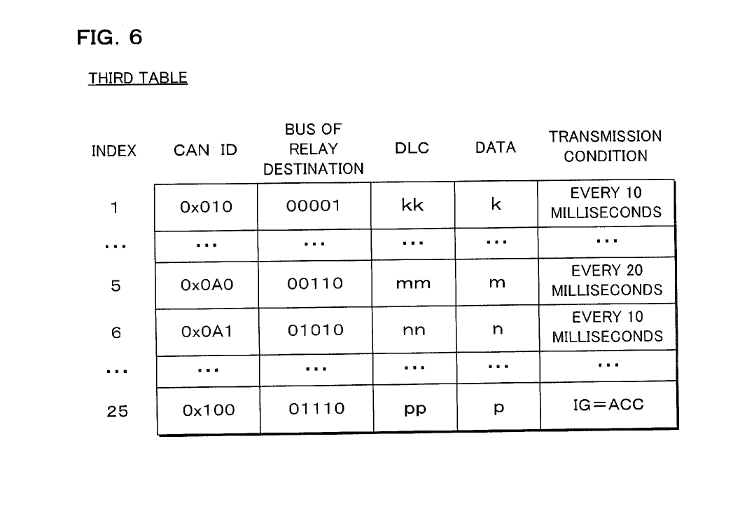

FIG. 6 is an explanatory view showing an example of the contents of the third table 73 of the routing table 37. The third table 73 includes records specific to the CAN messages to be transmitted. Each record includes the CAN ID, the information on the bus of the relay destination, the information length of the data part (DLC) included in the CAN message to be transmitted, the data storage area and the transmission condition. The transmission condition is not essential. The record type is determined, and the record lengths are constant. The records are stored from the record of the first index “1” (CAN ID is “0x010”) in order from the top of the area of the third table 73 on the flash memory 35.

In the example of the contents shown in FIG. 6, the CAN ID is expressed, for example, by 11 bits. The information on the bus of the relay destination is expressed, for example, by five bits. The bits correspond to “(a spare) (the communication bus 14) (the communication bus 13) (the communication bus 12) (the communication bus 11)”, and for each, being “1” indicates being a relay destination and being “0” indicates not being a relay destination. For example, the bus of the relay destination of a transmission CAN message with a CAN ID of “0x010” is the communication bus 11; that is, this message is a CAN message to be transmitted from the first communication unit 31 every ten milliseconds. Moreover, in the storage area of the data part of the transmission CAN message with a CAN ID of “0x010”, for example, “k” with an information length of “kk” is stored. The transmission condition may be a condition other than time such that the ignition position is the ACC (accessory). Besides this, the condition may be, for example, whether the signal value in the data satisfies some condition or not.

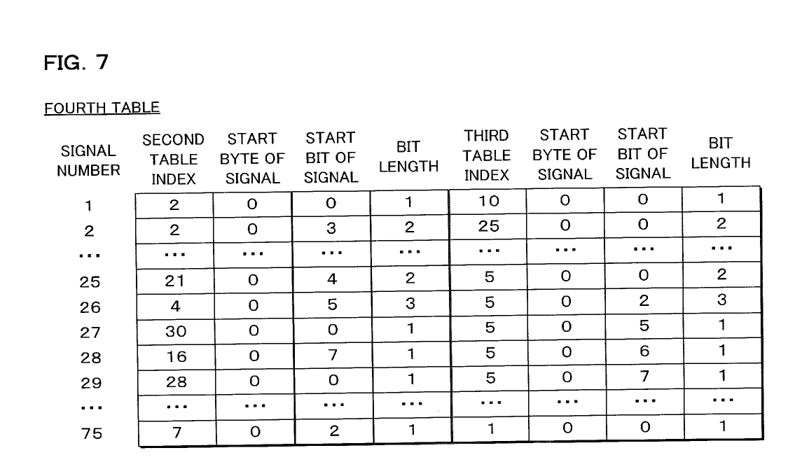

FIG. 7 is an explanatory view showing an example of the contents of the fourth table 74 of the routing table 37. The fourth table 74 includes information on the storage position of each signal in each of the second table 72 and the third table 73. The storage position is expressed by the start byte of the target signal in the data in the record of the second table 72 or the third table 73, the start bit of the signal in the start byte and the bit length of the signal.

In the example shown in FIG. 7, for example, it is indicated that the first signal is a signal included in the data storage area of the index “2” in the second table 72 storing the received CAN message and is stored in “1” bit from the “0”th bit of the “0”th byte of the data stored in the storage area. Moreover, it is indicated that the first signal is a signal to be included in the data storage area of the index “10” in the third table 73 storing the CAN message to be transmitted (relayed) and is to be stored in “1” bit from the “0”th bit of the “0”th byte of the data of the pertinent storage area. Likewise, it is indicated that the second signal is stored in “2” bits from the “3”rd bit of the “0”th byte of the data storage area of the index “2” in the second table 72 and is to be stored in “2” bits from the “0”th bit of the “0”th byte of the data storage area of the index “25” in the third table 73.

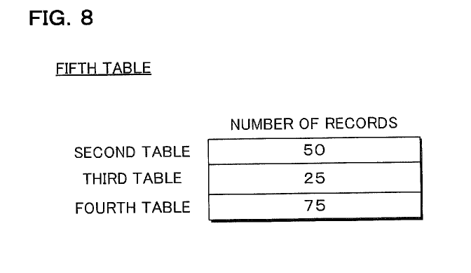

FIG. 8 is an explanatory view showing an example of the contents of the fifth table 75 of the routing table 37. The fifth table 75 stores the number of records of each of the second table 72, the third table 73 and the fourth table 74. In the example shown in FIG. 8, the number of records of the second table 72 is “50”, the number of records of the third table 73 is “25”, and the number of records of the fourth table 74 is “75”.

Based on the first to fifth tables 71 to 75 shown in FIG. 3, FIG. 4 and FIG. 6 to FIG. 8, the CPU 30 of the relay device 3 executes the relay processing as described below. The CPU 30 implements each of immediate relay processing and periodic relay processing based on the routing program 38. In the immediate relay processing, the CPU 30 directly relays a CAN message to one or a plurality of the first to fourth communication buses 11 to 14 at the point of time of reception. In the periodic relay processing, at the point of time of reception of a CAN message, the CPU 30 stores the data included in the CAN message in the data storage area (reception buffer) in the second table 72, and every time a predetermined period such as ten milliseconds elapses, periodically creates (stores) a CAN message in the third table 73 with reference to the second table 72 for data and transmits it. To implement the immediate relay processing and the periodic relay processing, the CPU 30 divides the task into reception processing when a CAN message is received and transmission processing that is executed periodically, and executes each.

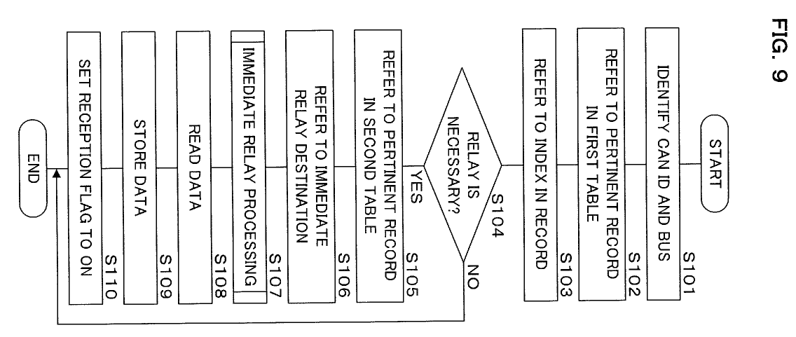

FIG. 9 is a flowchart showing an example of the processing procedure of the reception processing at the relay device 3. When the CPU 30 is notified of a reception interrupt by the processing based on the platform program 39, the CPU 30 executes the following processing based on the routing program 38:

The CPU 30 identifies the CAN ID of the received CAN message and which of the communication buses 11 to 14 the reception bus is (step S101). Based on the identified CAN ID and communication bus, the CPU 30 refers to the pertinent record in the first table 71 of the routing table 37 (step S102). As shown in FIG. 3, in the first table 71, for each of the communication buses 11 to 14, whether the CAN message needs to be relayed or not is indicated by the numerical value of the index for each of the CAN IDs of the received CAN messages. The CPU 30 refers to the index to the second table 72 of the pertinent record (step S103), and determines whether relay is necessary or not (step S104). At step S103, specifically the CPU 30 performs the processing of calling a function based on the routing program 38. The function reads the first table 71 of the routing table 37 with the communication bus and the CAN ID as arguments and returns a result as to whether the CAN message needs to be relayed or not based on the numerical value of the index in the first table 71 as the read return value.

When determining that relay is necessary at step S104 (S104: YES), the CPU 30 refers to the pertinent record in the second table 72 based on the index referred to at step S102 (step S105). The CPU 30 refers to the immediate relay destination of the record referred to (step S106), and executes the immediate relay processing based on the result of the reference (step S107).

After the immediate relay processing, the CPU 30 reads the data included in the received message (step S108). The CPU 30, based on the index referred to at step S102, stores the read data into the data field of the pertinent record in the second table 72 identified by the index (step S109), sets the reception flag to ON (step S110), and ends the processing.

When determining that relay is unnecessary based on the result of the reference at step S104 (S104: NO), the CPU 30 ends the processing without doing anything.

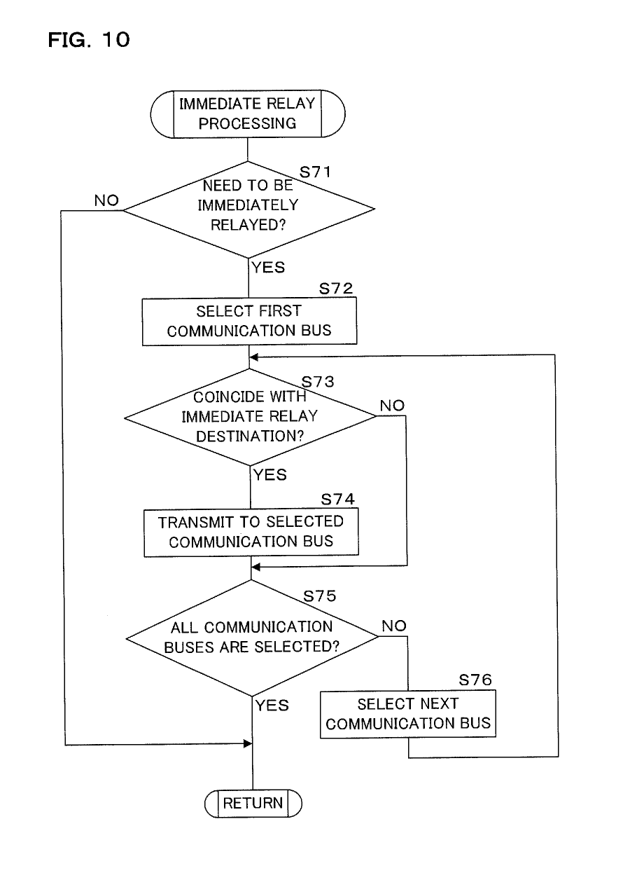

FIG. 10 is a flowchart showing an example of the processing procedure of the immediate relay processing at the relay device 3. The flowchart shown in FIG. 10 corresponds to the detailed procedure of step S107 of FIG. 9.

Based on the reference result at step S106 of FIG. 9, the CPU 30 determines whether the CAN message needs to be immediately relayed or not (step S71). Specifically, when the reference result is not “0x00(00000b)”, the CPU 30 determines that the CAN message needs to be immediately relayed.

When determining that the CAN message needs to be immediately relayed (step S71: YES), the CPU 30 selects the communication bus 11 as the immediate relay destination (step S72), and determines whether the immediate relay destination as the reference result and the selected communication bus 11 coincide with each other or not (step S73). When determining that they coincide with each other (S73: YES), the CPU 30 executes the processing of the platform program 39 in order to immediately transmit the received CAN message to the communication bus 11 having been selected, that is, from the third communication unit 33 connected to the selected communication bus 11 by the processing based on the platform program 39 (step S74), and proceeds to the next processing.

The CPU 30 determines whether all the communication buses 11 to 14 have been selected or not (step S75), and when determining that not all have been selected (S75: NO), selects the next communication bus 12, that is, the second communication unit 32 (step S76), returns the process to step S73, and executes the processing of immediate transmission to the next communication bus 12.

The CPU 30 also executes the processing of steps S72 to S74 for the communication bus 13 and the communication bus 14, and when determining that all the communication buses 11 to 14 have been selected (S75: YES), ends the immediate relay processing for the received CAN message, and returns the process to step S108 of FIG. 9.

When determining that the CAN message does not need to be immediately relayed at step S71 (S71: NO), the CPU 30 ends the immediate relay processing for the received message, and returns the process to step S108 of FIG. 9.

The processing procedures shown in the flowcharts of FIG. 9 and FIG. 10 will be described with a concrete example. As the concrete example, the processing when a CAN message with a CAN ID of “0x100” is transmitted from the communication bus 12 will be described.

The CPU 30 receives a notification of reception of the CAN message at the second communication unit 32, and identifies the CAN ID as “0x100” and the communication bus as the “communication bus 12” (S101). The CPU 30 refers to the first table 71 of the routing table 37 for the “0x100”-th record of the communication bus 12 (S102), and calls a function that returns the result as to whether the CAN message needs to be relayed or not (S103). By the function, as shown in FIG. 3, since “OK” is returned because the index is “21” and not “0”, the CPU 30 determines that relay is necessary (S104: YES). The CPU 30 refers to the pertinent record in the second table 72 based on the index “21” (S105). The CPU 30 refers to the immediate relay destination “01001b” in the record referred to (S106), supplies the immediate relay destination referred to, and executes the immediate relay processing of S107.

In the immediate relay processing, since the immediate relay destination referred to is not “0x00”, the CPU 30 determines that the CAN message needs to be immediately relayed (S71: YES). The CPU 30 selects the first communication bus 11 (S72), determines that it coincides with the immediate relay destination since the end bit corresponding to the communication bus 11 of “01001b” is “1” (S73: YES), and directly transmits the CAN message having been received, by the first communication unit 31 corresponding to the selected communication bus 11 (S74). Since not all the communication buses 11 to 14 have been selected (S75: NO), the CPU 30 selects the next communication bus 12 (S76). The CPU 30 returns the process to step S73, determines that it does not coincide with the immediate relay destination since the second-to-last bit corresponding to the communication bus 12 of the immediate relay destination “01001b” is “0” (S73: NO), and advances the process to step S75. Then, since not all the communication buses 11 to 14 have been selected yet (S75: NO), the CPU 30 selects the next communication bus 13 (S76). The CPU 30 returns the process to step S73, determines that it does not coincide with the immediate relay destination since the third-to-last bit corresponding to the communication bus 13 of the immediate relay destination “01001b” is “0” (S73: NO), and advances the process to step S75. Since not all the communication buses 11 to 14 have been selected yet (S75: NO), the CPU 30 selects the next communication bus 14 (S76). The CPU 30 returns the process to step S73, determines that it coincides with the immediate relay destination since the fourth-to-last bit corresponding to the communication bus 14 of the immediate relay destination “01001b” is “1” (S73: YES), and directly transmits the CAN message having been received, by the fourth communication unit 34 corresponding to the selected communication bus 14 (S74). At step S75, the CPU 30 determines that all the communication buses 11 to 14 have been selected, and returns to step S108 of FIG. 9.

The CPU 30 reads data “v” included in the received CAN message (S108). The CPU 30 writes the data into the data storage area of the referred record of the second table 72 in the routing table 37 (S109). The CPU 30 sets the reception flag to “ON” (S110), and ends the processing.

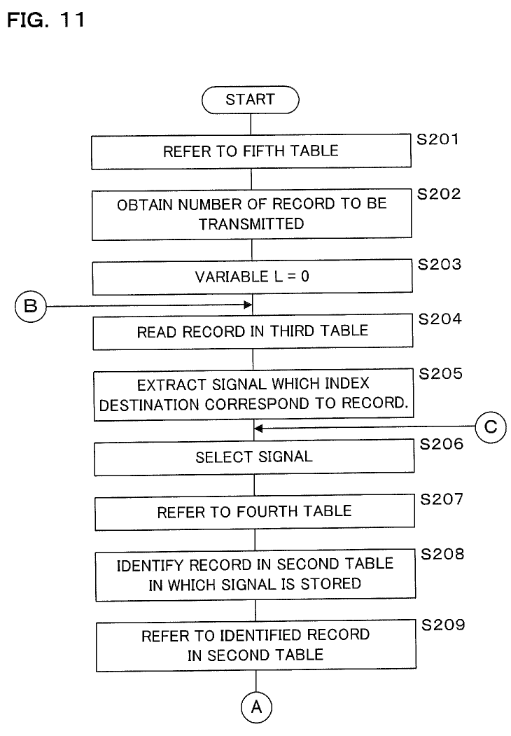

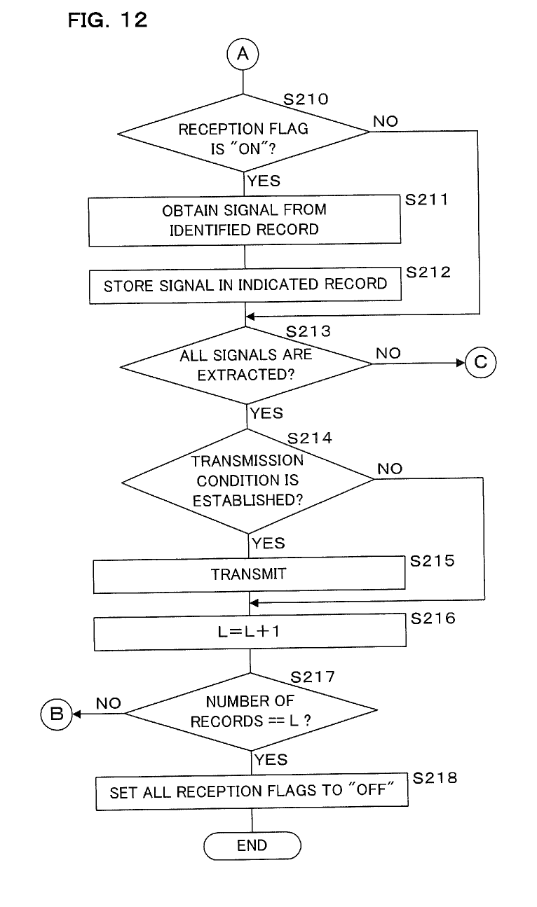

Next, the transmission processing at the relay device 3 will be described. FIG. 11 and FIG. 12 are flowcharts showing an example of the processing procedure of the transmission processing at the relay device 3. The relay device 3 counts a predetermined period of, for example, ten milliseconds by a non-illustrated timer unit, and notifies the CPU 30 of a timer interrupt every time ten milliseconds elapses. When the notification of the timer interrupt is provided, the CPU 30 executes the following processing based on the routing program 38:

The CPU 30 refers to the fifth table 75 (step S201), and obtains the number of records in the third table 73, that is, the number of CAN messages to be transmitted (step S202).

The CPU 30 substitutes “0” for a variable L for counting (step S203), and reads the obtained number of records from among the records in the third table 73 in order from the top (step S204). The CPU 30 extracts, from the fourth table 74, signals which index destination of the third table 73 corresponds to the pertinent record (step S205). The CPU 30 selects one from among the extracted signals (step S206), refers to the fourth table 74 for the record of the selected signal (step S207), and identifies in which in the second table 72 the signal is stored (step 208).

The CPU 30 refers to the identified record in the second table 72 (step S209), and determines whether the reception flag is “ON” or not (step S210). When the reception flag is “ON” (S210: YES), the CPU 30 obtains the signal from the storage position identified at step S208 (step S211), and stores the obtained signal in the storage position in the third table 73 indicated by the record referred to at step S207 (step S212).

The CPU 30 determines whether all the signals extracted at step S205 have been selected or not (step S213), and when determining that not all have been selected (S213: NO), returns the process to S206, and selects the next signal (S206).

When determining that the reception flag in the record of the second table 72 where the signal selected next is stored is “OFF” (S210: NO), the CPU 30 advances the process to step S213.

When determining that all have been selected at step S213 (S213: YES), since the data of the CAN message to be transmitted is completed, the CPU 30 determines whether the transmission condition of the pertinent record read at step S204 is established or not (step S214). When determining that the transmission condition is established (S214: YES), the CPU 30 supplies the CAN message including the data part in the pertinent record to any of the first to fourth communication units 31 to 34 corresponding to the relay destination bus in the pertinent record and causes it to transmit the CAN message (step S215).

Then, the CPU 30 adds “1” to the variable L for counting (step S216), and determines whether the number of records obtained at step S202 and the variable L coincide with each other or not (step S217). That is, the CPU 30 determines whether the processing has been executed for all the records in the third table 73 or not (S217). When determining that they do not coincide with each other at step S217 (S217: NO), the CPU 30 returns the process to step S204 and reads the next record (S204).

When determining that the transmission condition is not established at step S214 (S214: NO), the CPU 30 advances the process to step S216, and executes the processing for the next record.

When determining that the number of records obtained at step S202 and the variable L coincide with each other at step S217 (S217: YES), the CPU 30 sets the reception flags of all the records of the reception table to “OFF” (step S218), and ends the processing.

The processing procedure shown in the flowcharts of FIG. 11 and FIG. 12 will be described with a concrete example. As the concrete example, the processing when the record with a CAN ID of “0x0A0” of the index “5” is read from the contents which are the example of contents in the third table 73 of FIG. 6 (S204) will be described.

The CPU 30 extracts signals (25 to 29) which index destination corresponds to the record of the index “5” in the third table 73, from the fourth table 74 (S205). The CPU 30 selects the 25th signal of the extracted signals (S206), and refers to the fourth table 74 (S207) The CPU 30 identifies the record of the index “21” in the second table 72, the record storing the selected signal (S208).

The CPU 30 refers to the “21”st record in the second table 72 (S209), and determines that the reception flag is “ON” (S210: YES). The CPU 30 obtains the signal from the data storage area of the pertinent record in the reception table, with reference to the storage position identified at step S208, that is, the start byte “0”, the start bit “4” and the bit length “2” (S211). Then, based on the information on the storage position in the third table 73 referred to at step S207, the CPU 30 stores the information on the obtained signal two bits from the “0”th bit of the “0”th byte of the data storage area of the record of the index “5” of the third table 73 (S212).

The CPU 30 then selects the “26”th signal (S206), and obtains the signal from the record of the index “4” of the second table 72 with reference to the fourth table 74 (S212). For each of the extracted signals (25 to 29), the CPU 30 completes the record of the index “5” of the third table 73, that is, a CAN message with reference to the fourth table 74. The CPU 30 determines whether the transmission condition is established or not (S214) The CPU 30, since the transmission condition is that the transmission period is every 20 milliseconds, executes transmission of the pertinent record of the transmission table (S215) once every two transmissions performed every ten milliseconds.

As described above, by adopting a structure in which the routing table 37 includes the fourth table 74 including index information, the tables 71 to 75 each have a predetermined format and the method of reading each record is set to a specific method in the above-described processing procedures, even if the routing table 37 is replaced with, for example, the routing table 40, it is unnecessary to change the processing based on the routing program 38. In particular, since the routing table 37 or the routing table 40 is structured to include the index information, it is possible to manage the received information in accordance with the replaced different routing table 40 and create the information to be relayed.

Further, since the tables are adequately divided as in FIG. 3, FIG. 4 and FIG. 6 to FIG. 8, an excellent advantage is produced in that it is possible to reduce the capacity of the routing table 37 and save the storage area of the flash memory 35.

The present embodiment disclosed as described above should be considered as illustrative in all respects and not restrictive. The scope of the present invention is defined by the claims rather than by the meaning described above, and it is intended that all changes that fall within the meaning and scope equivalent to the claims are embraced.

1-7. (canceled)

8. A relay device comprising:
a plurality of communication units connected to different communication buses, respectively;
a rewritable storage unit; and
a processor that executes relay process of transmitting one or a plurality pieces of information received at one or a plurality of the communication units, by another one or a plurality of the communication units, based on a computer program stored in the storage unit, wherein
the storage unit stores a routing table that identifies a relay destination of the received information,
and
the routing table includes:
a first table recording necessity or unnecessity of relay of the information for each piece of identification information of the information and a storage destination of the information when relay is necessary;
a second table for recording an area where received information is stored;
a third table including a relay destination and an area storing information associated with the relay destination and to be relayed;
a fourth table recording index information representative of a storage destination of information; and
a fifth table recording the number of pieces of information in the third table.

9. The relay device according to claim 8, wherein
the processor is provided with an execution part including:
a part for referring to the first table when information is received at any of the communication units;
a part for referring to the first table for the storage destination of the information when it is necessary to relay the information, based on the first table; and
a part for storing the information in the storage destination in the second table.

10. The relay device according to claim 8, wherein
the second table includes a relay destination so as to be associated with the storage area,
and
the processor is provided with an execution part including:
a part for referring to the first table when information is received by any of the communication units;
a part for referring to the first table for the storage destination of the information when it is necessary to relay the information, based on the first table; and
a part for transmitting the information to the relay destination associated with the storage destination in the second table.

11. The relay device according to claim 8, wherein
the processor is provided with an execution part including:
a part for referring to the third table;
a part for identifying the storage destination, in the second table, of the information stored in the storage destination of the third table, based on the fourth table;
a part for reading information from the identified storage destination;
a part for storing the read information into the storage destination of the third table; and
a part for transmitting the stored information to the associated relay destination.

12. The relay device according to claim 11, wherein
the processor is provided with a part for reading the number of pieces of information from the fifth table, and
refers to the third table by an amount equivalent to the number of read pieces of information.

13. A communication harness including:
the relay device according to claim 8; and
a plurality of communication buses connected to the communication units of the relay device, respectively.

14. A communication system comprising:
a plurality of communication devices that transmit and receive information;
a plurality of communication buses connected to the communication devices, respectively; and
the relay device according to claim 8 to which the communication buses are connected.
